(19) United States
(12) Patent Application Publication
(10) Pub. No.: US 2002/0130901 A1
(43) Pub. Date: Sep. 19, 2002

(54) Enhanced program listing

(76) Inventor: Rajko Milovanovic, Plano, TX (US)

Correspondence Address: Robert L. Troike, Texas Instruments Incorporated, P.O. Box 655474, MS 3999, Dallas, TX, 75265, US

(21) Appl. No.: 10/051,470

(22) Filed: Jan. 18, 2002

Related U.S. Application Data
(60) Provisional application No. 60/276,192, filed on Mar. 16, 2001.

(51) Int. Cl. G09G 5/00

(52) U.S. Cl. 345/744; 345/717; 345/721; 345/727

(57) ABSTRACT

An improved listing or menu is provided wherein the items of a listing are sequentially enhanced to enable assist the user in selecting the items on the list. the enhancement may be audio such as from MP3 or pictures such as from MPEG or may be user-defined enhancements.

### FIELD OF INVENTION

This invention relates to menus and/or listings and more particularly to enhancing menus and/or listings.

### BACKGROUND OF INVENTION

When a user reviews or browses a listing of media items such as video items, audio items, etc. in an off the network connection, or while on the network, or off local storage, etc. or other source a list of menu item identifiers (IDs) or names (heretofore: name) pulled off the source's index/database, etc., is presented (written text or speech) to him or her on the screen, LCD, speaker, etc. For example, a menu or listing of available MP3 songs or MPEG video clips is presented on the computer screen to select from. The listing could also be a listing of available computer programs presented. There are various methods and apparatus for generating menus in a menu driven computer system. See for example, U.S. Pat. No. 5,041,967 of Ephrath et al., incorporated herein by reference.

As the complexity and number of computer programs has increased is has become increasingly difficult for the user to recall the media item on the menu or listing actually refers to.

Whenever a user is not exactly certain about the media item name, the user will prefer to get a displayed or otherwise presented list of media item names that the user will recognize. If the list does not contain the item name sought, or if the user is not sure about his/her recall even if the item is actually contained in the list presented, the user needs to scan down the list and try to decide if the name currently looked at (pointed by) refers to the actual media item sought. The key challenge is the user often finds it hard to instantaneously associate the ASCII name with the user's perceived notion of the actual media item's property other than ASCII string (such as for example music tune or segment of video).

This may be particularly true in the situations where the ASCII names are disproportionately cryptic such as, for example, “Mozart Symphony No. 17” where a less cryptic would be a few easily recognized bars of the symphony.

### SUMMARY OF INVENTION

In accordance with one embodiment of the present invention the listing software contains appropriate bulls eye sample enhancements to enhance selection and/or recall the items on the list.

### DESCRIPTION OF THE DRAWINGS

FIG. 1 illustrates a general block diagram of a computer hardware system in which the present invention might find use.

FIG. 2 shows a general block diagram of a computer software system that may be resident on the computer hardware of FIG. 1 in which the present invention may find use.

FIG. 3 illustrates the expanded plug-in menus according to one embodiment of the present invention; and

FIG. 4 illustrates a flow chart of the system according to one embodiment of the present invention.

### DESCRIPTION OF PREFERRED EMBODIMENTS

Referring more particularly to FIG. 1 of the drawings, there is shown a general block diagram of a computer hardware system comprising a Central Processing Unit (CPU) 10 and a Random Access Memory (RAM) unit 11. Computer programs stored in the RAM 11 are accessed by CPU 10 and executed, one instruction at a time, by CPU 10. Data, stored in other portions of RAM 11, are operated upon by the program instructions accessed by CPU 10 from RAM 11, all in accordance with well-known data processing techniques.

Central Processing Unit (CPU) 10 also controls and accesses a disk controller unit 12 which, in turn, accesses digital data stored on one or more disk storage units such as disk storage unit 13. In normal operation, programs and data are stored on disk storage unit 13 until required by CPU 10. At this time, such programs and data are retrieved from disk storage unit 13 in blocks and stored in RAM 11 for rapid access.

Central Processing Unit (CPU) 10 also controls an Input-Output (10) controller 14 which, in turn provides access to a plurality of input devices such as CRT (cathode ray tube) terminal 15, as well as a plurality of output devices such as printer 16. Terminal 15 provides a mechanism for a computer operator to introduce instructions and commands into the computer system of FIG. 1, and may be supplemented with other input devices such as card and tape readers, remotely located terminals, optical readers and other types of input devices. Similarly, printer 16 provides a mechanism for displaying the results of the operation of the computer system of FIG. 1 for the computer user. Printer 16 may similarly be supplemented by line printers, cathode ray tube displays, phototypesetters, graphical plotters and other types of output devices. The computer system may further include access to an Internet network via a network. The computer system may then receive and/or store programs received over the network. The programs may then be played on the display and/or heard on speakers.

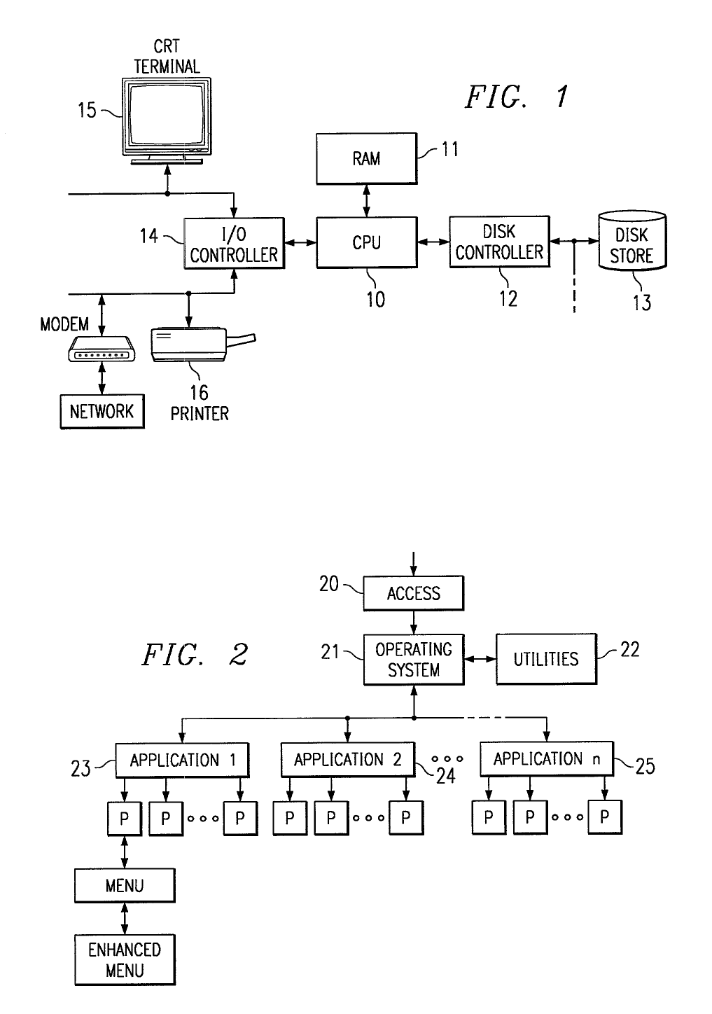

Referring to FIG. 2 a typical computer system includes software with an access mechanism 20 which, for simple personal computers, may comprise no more than turning the system on. In larger systems, providing service to a larger number of users, login and password procedures would typically be implemented in access mechanism. Once access mechanism has completed the login procedure, the user is placed in the operating system environment. Operating system 21 coordinates the activities of all of the hardware components of the computer system (shown in FIG. 1) and provides a number of utility programs 22 of general use to the computer user. Utilities 22 might, for example, comprise assemblers and compilers, mathematical routines, basic file handling routines and system maintenance facilities. The utilities 22 may include a modem to an Internet network such as the World Wide Web and a user may wish to access or store programs from the Internet as well as other programs made available. A program generating a listing or a menu of these programs is stored and provided so the user can select the desired program.

The computer system described above is only by way of example and the computer system may be found in many forms such as in a cellular phone or Internet access machine, TV set top box, etc. The display can be, for example, a CRT screen, or an LCD screen for pictures or a speaker for audio.

The constituents of the computer system of FIG. 1 and their cooperative operation are well known in the art and are typical of all computer systems, from small personal computers to large mainframe systems. The architecture and operation of such systems are well known and, since they form no part of the present invention, will not be further described here.

It is the programmed processes which actually perform the tasks necessary to carry out the purpose of the corresponding application program. In order to make effective use of these application packages, the user must be able to execute the processes at the time, and in the sequence, necessary to accomplish the user's goals. It is the proper selection of these application processes toward which the present invention is directed. In an effort to aid the user a menu or listing of the programs is stored and presented.

The programs stored may be off the web and may be MP 3 audio or MPEG pictures, etc. In that case the hardware system may be connected via a modem and browser to an Internet or Intranet link. The hardware system may be any similar system with a processor, storage and menu or listing generator. In accordance with one embodiment of the present invention the menu and/or listing system includes recall enhancing menu or listing that contains appropriate media player plug-ins to enhance recall for the items off the menu list. The browsing software may include HTTP-talking or HTML-parsing capable software. In accordance with one embodiment of the present invention whenever the displayed ASCII list of media items names shows up on the screen or LCD or speaker the enhancing menu provides an enhancing recall sample or “bulls eye” for the first item off the list. This is automatically rendered on the appropriate rendering device such as the screen, LCD or speaker. The rendering may be by an audio medium item, sound clip played or by video media item, video clip, or still picture displayed. This “bulls eye” sample is the most relevant short sample which most succinctly captures the recall content of that media item. If this is generated at the local user's hardware the user selects the most relevant short that works as a recall item. This may also be generated at the Internet source location and recall plug-ins sent from the Internet source or sources.

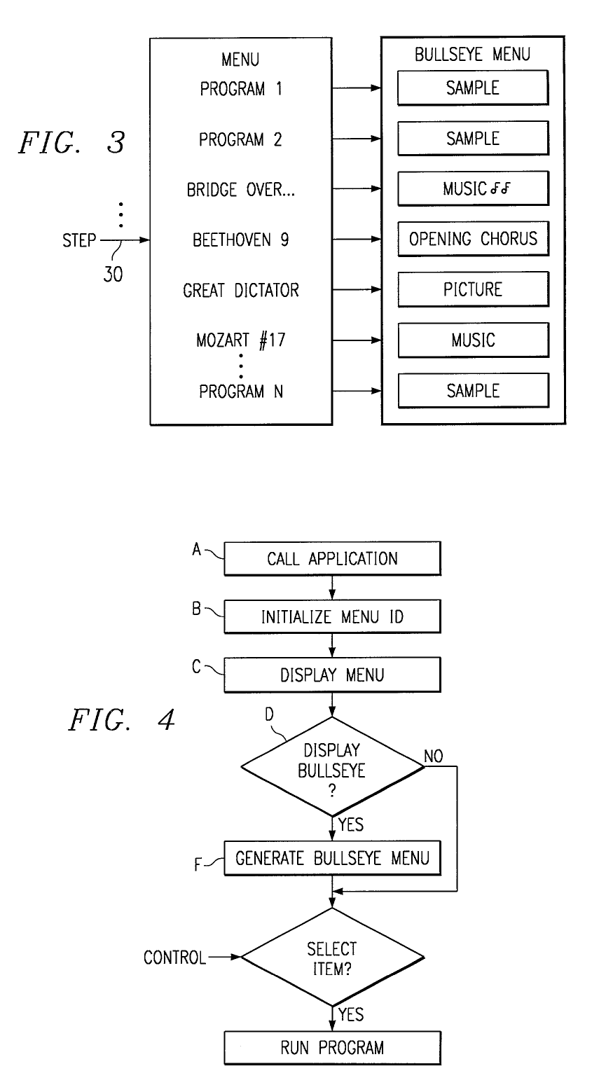

Referring to FIG. 3 for example is a menu listing programs such as Program 1, Program 2, etc., including Beethoven 9, Mozart Symphony No. 17 or “Great Dictator.” For each of these or selected ones there is a corresponding “bulls eye” or recall plug-in. As stated above this may be a video sequence such as MPEG or MP3 audio sequence that the user or source program provides. For the Beethoven's 9^{th} Symphony program, for example, a few bars of the opening choruses. For the Mozart Symphony No. 17 the less cryptic sequence of a few of the most easily recognized bars of music and for the movie “Bridge on the River Quai.” a few bars of music from the movie. For the Great Dictator, the picture of Charlie Chaplin as Hitler kicking the Globe with his rear.

The listing may be from HyperText Markup Language (HTML) used on the World Wide Web where the listing is the web pages with HTML tags or codes embedded in the text. The HTML in addition to defining the page layout, fonts and graphic elements contains the hypertext links to other documents on the web. Each link contains the URL (Uniform Resource Language) or address of a web page residing on the same server or any other server worldwide. These addresses or URL locations may be provided with the enhancement menu with the enhancement plug-ins so the user can more easily recall what it is about or have a sample of the program contents.

As the reviewing or browsing pointer 30 (or default proxy for it, quantizing agent scanning down the list with a fixed stepping time) moves/jumps through the displayed ASCII list of media item names, for each highlighted or otherwise pointed to items its “bulls eye” or plug-in sample is rendered without actually selecting a clicking on the item. The selecting or clicking on the item is reserved for selecting the item to run the program. The “bulls eye” or plug-in time period is just sufficient so it is can be considered as the bulls eye names down the list. The size of the bulls eye sample can be varied depending on the available capacity of the processor, memory, and the bandwidth path to the source of the bulls eye samples (disk/remote server, etc.).

FIG. 4 illustrates operational program where after the application is called Step A, a menu is initialized (Step B) and displayed (Step C). The user may be asked to go to the “bulls eye” mode or not (Step D) and simply select the item as in the past (Step E) or if unsure can select the “bulls eye” generation mode (Step F) wherein sequentially the items are provided by the stopped pointer with the enhancing plug-ins that aid the user to enhance or allow the user to recall what the program is about. The user then selects the desired program (Step E) to run the program. The “bulls eye” generation may be a picture or sound track plug-in. The bulls eye may also be operated by a separate highlighting and selection operation to assist the user in the selection process without viewing or listing to the other identified items.

The encoded bulls eye sample can be not only rendered with encoded bulls eye sample and using the plug-in (which does the decoding), but also with the “raw ready to render” sample (i.e. decoded up front) which only has to be rendered. This is workable as a sample that can be of a very short duration (a couple of most characteristic seconds is plenty for recall), and limited in resolution. Even if the fall item is at high resolution/sampling rate, the number of pixels per bullseye sample can be stored and decoded (ready to be rendered) at a much smaller resolution. This lesser quality bullseye sample is still sufficient for recall.

The application may be used in any computer storage applications including computer system TV set top box, and wireless, but also remote access and networking systems.

It should be clear to those skilled in the art that further embodiments of the present invention may be made by those skilled in the art without departing from the teachings of the present invention.

In the claims

1. A listing comprising:
an initial listing of items;
an enhanced listing of programs of said items on said initial listing wherein said items on said enhanced listing include enhancements to assist the user in selecting a list of the programs;
and means for selecting programs on said listing.

2. The listing of claim 1 wherein said enhanced listing is presented sequentially item by item to provide enhancement presentations for a brief period of time sufficient to allow the user to decide on a selection.

3. The combination of claim 1 wherein said enhancements are audio sound sequences.

4. The combination of claim 1 wherein said enhancements are pictures and/or video sequences.

5. The combination of claim 3 wherein said audio sound sequences are from an MP 3 plug-ins or plug-ins for other video or image formats.

6. The combination of claim 4 wherein said pictures are from an MPEG 4 or JPEG plug-in or plug-ins for other video or image formats.

7. A computer system comprising:
a processor,
an operation system memory containing programs and a presentation means;
an enhancement listing generator wherein listings of programs are sequentially provided with enhanced presentations on said presentation means to assist user to select the programs; and
means for selecting said programs.

8. The system of claim 7 wherein said enhanced presentations are pictures.

9. The system of claim 7 wherein said enhanced presentations are saved.

10. The system of claim 7 wherein said enhanced presentations are user generated and stored in a recall menu.

11. The system of claim 7 wherein said system includes an Internet connection and browser and said enhanced presentations are received from a remote source.

12. The listing of claim 1 wherein said listing items are HTML tags with addresses and said enhancements are samples from the addresses.
